(19) United States
(12) Patent Application Publication
(10) Pub. No.: US 2017/0034700 A1
(43) Pub. Date: Feb. 2, 2017

(54) System, Method and Device for Consistently Configuring and Securing Devices Installed in Close Physical Proximity

(71) Applicant: MasterPeace Solutions Ltd., Columbia, MD (US)

(72) Inventors: Andrew Samuel Cohen, Fulton, MD (US); Edward Rosemond Stanford, Highland, MD (US)

(73) Assignee: MasterPeace Solutions Ltd., Columbia, MD (US)

(21) Appl. No.: 15/222,382

(22) Filed: Jul. 28, 2016

Related U.S. Application Data
(60) Provisional application No. 62/198,000, filed on Jul. 28, 2015.

(51) Int. Cl. H04W 12/06; H04L 29/06; H04W 12/02; H04L 9/32

(52) U.S. Cl. CPC H04W 12/06; H04L 9/3268; H04L 63/0823; H04L 63/062; H04W 12/02

(57) ABSTRACT

It is an object of the present invention that trust between devices is enhanced by distributing a shared secret (e.g. an X.509 certificate or other cryptographic or shared secret mechanisms), utilizing a short range communication mechanism, thereby permitting those devices to securely authenticate and authorize sensitive commands to each other in communication over the Internet or an untrusted network. A system, method and device are also provided for securely and consistently configuring multiple networked devices with network credentials, server addresses, and web service credentials, and standardizing and enforcing any inventory, device management, or other policies desired by a user/operator at the time of installation, utilizing a short range communication mechanism.

### CROSS REFERENCE TO RELATED APPLICATIONS

This application claims the benefit of U.S. Provisional Patent Application No. 62/198,000 filed on Jul. 28, 2015, the contents of which are herein incorporated by reference in its entirety.

### FIELD OF THE INVENTION

The invention relates to methods of configuration, authentication, and secure communication amongst devices over the Internet.

### BACKGROUND

The growing prevalence of the Internet of Things (IOT) devices (or “connected devices) exacerbates existing security concerns regarding computer and network security in consumer and corporate settings, with particular concerns relating to industrial or Operational Technology (OT). IOT devices present special security challenges, in that such devices are often installed by persons not skilled in cybersecurity, who must frequently choose the correct secured network from a multitude of choices and configure web services and access credentials. Also, IOT devices come from a variety of manufacturers, in a variety of form factors, with a variety of installation and configuration mechanisms. No emerging standards are yet visible in this area. Also, IOT devices are often small and physically distributed throughout the purchasing enterprise, rather than locked away in a machine room, which can expose them to unwanted physical access and offers significant inventory and management challenges. Also, IOT devices may be exposed to many wireless networks, even when properly installed.

Additionally, IOT devices afford attackers an unprecedented ability to do physical, rather than informational, damage, whether by causing fires, damaging equipment, spoiling production runs, etc. It is thus simultaneously harder to secure, and more important to secure, such devices than ever before.

Cybersecurity can only work if it is used. Traditional server/desktop/mobile computing already struggles to fully implement existing best practices, such as unshared, non-default passwords, use of strong wireless passwords and two-way secure endpoint access technologies, and cryptographic token distribution for authentication and access control.

In particular, a wireless connected device, by definition, requires network configuration and credentials to access the wireless network. Successful configuration of such devices is required as part of their installation. Erroneous and/or inconsistent configuration of devices raises operational and security issues. Additionally, a “smart” device will typically access or be accessed by one or more web services: to do so securely, it must know the relevant web address and possess one or more certificates or other cryptographic tokens to authenticate and authorize such access.

The extra difficulties associated with installation, configuration, and management of IOT devices described above amplify these concerns, offering an inviting attack surface for both the connected devices and the larger networks and systems in which they participate. The invention disclosed herein is designed to mitigate these issues.

### SUMMARY OF THE INVENTION

A system, method and device are provided for securely and consistently configuring multiple networked devices with network credentials, server addresses, and web service credentials, and standardizing and enforcing any inventory, device management, or other policies (such as taking in-situ photographs, recording serial numbers, etc.) desired by a user/operator at the time of installation. In one embodiment, the system of the present invention utilizes a short range communication mechanism (e.g. Wi-Fi, Bluetooth, Near Field Communications, Physical Data exchange, or other proximity reliant communications mechanism).

It is an object of the present invention that trust between devices is enhanced by distributing a shared secret (e.g. an X.509 certificate or other cryptographic or shared secret mechanisms), thereby permitting those devices to securely authenticate and authorize sensitive commands to each other in communication over the Internet or an untrusted network.

In one embodiment of the invention, a non-transitory computer-readable medium having recorded thereon a program that causes a device running an application to execute a method, comprises: distributing, via a key generator module of a control device, a certificate from the control device to an IOT device or application via a non-internet, proximity-based communications protocol, wherein the non-internet proximity based communications protocol comprises NFC or Bluetooth communications, or another suitable means of communication.

In another embodiment, system for device configuration comprises: a configuration database maintained with pre-defined approval configurations for a plurality of target devices to be installed within a local network of devices; and a control device, wherein the control device is configured with a configuration module configured to permit the control device to execute two related processes: one to create, review, and store in the configuration database, approved configurations for a device, and one to retrieve and apply the device-specific approved configuration to a target device, wherein the target device is an IOT device, and wherein the target device configuration is installed in physical proximity to the control device using local communications channels; and wherein an approved configuration is defined by the user/owner, and may maintain different approved configurations for each type of device used and/or the location or purpose of each device; and/or wherein an approved configuration for a device may include automatically-generated unique names, usernames, passwords, and the like, generated from a template or by any other mechanism.

In another embodiment, the system comprises a devices configured with a key generator module configured for distributing a shared secret, wherein the shared secret is an X.509 certificate or other cryptographic or shared secret mechanisms, thereby permitting devices to securely authenticate and authorize sensitive commands to each other in communication over the Internet or an untrusted network.

In another embodiment, the system comprises multiple approved configurations to configure wireless network settings (SSID, passphrase, etc.) or one or more devices, and to reset the username/password combinations used to secure those devices from factory defaults to unique values, and to execute a manual execution script, recording serial numbers, device position, and other desirable information for inventory, device provenance, and similar purposes.

In one embodiment, IOT devices comprise one or more connected devices comprising a portable electronic device, a smartphone, a camera, a home electronic device, and the like.

In one embodiment, the locality of the local communications channel is used to configure devices in physical proximity to the control device is ensured by using low-power, short range communications protocols such as Bluetooth, ZigBee, or any similar successor protocols.

In yet another embodiment, a method for applying an approved configuration to an un-configured device, comprises: retrieving, via a control device configured with a configuration module and a mobile configuration application, from a configuration database an approved configuration; connecting, via the control device to a web application; authenticating the control device as belonging to an appropriate installer, either by physical proximity, username and password, or cryptographic certificates; displaying any instructions for manual input required in order to activate the target device; initiating a mobile hot spot or other short-range wireless network with which the target device will connect, via the mobile configuration application on the control device; generating, via the mobile configuration application, any certificates, passwords or other authentication information; installing network credentials; and returning a record of activities carried out and information collected for inclusion in an inventory database.

### BRIEF DESCRIPTION OF THE DRAWINGS

FIG. 1 shows an overview of a system for establishing secure connections between IOT devices according to one embodiment of the present invention.

FIG. 2 shows an overview of a system for establishing secure connections between IOT devices according to one embodiment of the present invention.

FIG. 3 shows an overview of a system for establishing secure connections between IOT devices according to one embodiment of the present invention.

FIG. 4 shows an overview of a system for configuration of an un-configured IOT device according to one embodiment of the present invention.

FIG. 5 shows an overview of a process for configuration of an un-configured IOT device according to one embodiment of the present invention.

### DETAILED DESCRIPTION OF THE INVENTION

As used herein, the following terms are used in accordance with the following definitions:

As used herein, “cert” refers to X.509 cryptographic certificate, or any successor standard.

As used herein, “cloud” refers to a collection of web servers located somewhere on the Internet.

As used herein, “DANE” refers to the DNS-based Authentication of Named Entities protocol.

As used herein, “DNS” refers to Domain Name System, which is used to convert text strings to Internet Protocol version 4 (IPv4) (IPv4)/Internet Protocol version 6 (IPv6) and IPv4/IPv6 addresses.

As used herein, “enclave” refers to a collection of networked devices residing at times in and around a specific physical location whose interactions are secured by the present invention.

As used herein, “enclave cert(ificate) generator” refers to a device that generates all certificates used to secure enclave communications, and transmits them only over short range communications.

As used herein, “IOT” refers to the Internet of Things, and IOT devices, which collectively refer to a network of physical devices, vehicles, buildings and other items—embedded with electronics, software, sensors, actuators, and network connectivity that enable these objects to collect and exchange data; feature an IP address for internet connectivity, and the communication that occurs between these objects and other Internet-enabled devices and systems. “IOT devices” and “devices” may be used interchangeably throughout the specification, and the scope of the invention encompasses all form and manner of IOT devices presently known or developed.

As used herein, “Local Security Rules Engine” refers to a policy administrator that can be included in this invention, which provides central point of administration for enclave-specific security policies.

A system and method as described herein addresses the device configuration and installation issues discussed herein, and provides for secure certificate distribution to enable secure communications, in addition to secure configurations of IOT devices.

In one embodiment, a portable electronic device equipped for wireless communications is configured with a key generator module. The key generator module is embodied as an application loaded on the portable electronic device, the device comprising a mobile phone (“smartphone”), tablet, or on a purpose-built handheld device equipped with appropriate wireless communications. In one embodiment, the key generator module is preconfigured with automated and manual processes configured for manual input, that are executed during a device installation. The device key generator module operates with a configuration modules, the configuration module configured to maintain one or more lists of known and approved devices and device configurations. In one embodiment, the configuration module comprises a specialized web service.

In one embodiment, the configuration module stores and maintains a list of known and approved IOT device configurations, and in turn functions to authorize a request via the key generator module to add one or more devices to a group of devices in an organization or enclave, or otherwise-connected devices, and provides a trustworthy inventory of all devices added in this manner.

The key generator module is also configured, in some embodiments, for distribution of cryptographic tokens to provide device identity and support identity and access management functions via, in part, the configuration module.

The key generator module may be configured as a mobile application which is temporarily authorized to automatically configure specific IOT devices to join the organization: it supplies automated configuration, and enforces the completion of any manual steps required.

In one embodiment, the configuration module operates via a web service that provides a permanently-accessible list of one or more policies and configurations to be applied to a particular device or group of devices, and the devices that have been enrolled in, an enclave of connected device

The particular embodiments of the invention comprise a system and method providing a security framework for consistently installing and creating secure enclaves of IOT devices that are defined by the device owners in specific locations, such as a home or office. The system and method of the present invention allow IOT devices from multiple device manufacturers and IOT service providers, to be organized into user/owner-defined secure enclaves in a physical environment assigned by the user/owner.

There is no mechanism in current practice by which the physical proximity of devices in a home, office, or factory can be used to improve the security of inter-device communication. In all embodiments, a system and method as disclosed herein leverages the physical proximity in order to create a trusted enclave of devices.

Crucially and uniquely, the required installation processes for each type of device to be installed in the enclave are defined and maintained by the user/operator, and not the device manufacturer. This affords connectivity of devices from a multitude of manufacturers, and to optimize the installation process of each device to emphasize its security, or convenience as required by the user/owner, while providing a reliable inventory and audit trail for every device installed in this manner.

In one embodiment, installation policies can be planned, standardized and enforced in this manner, via the system and method described herein and include, but are not limited to: configuration of networks to which one or more devices is permitted to connect; network credentials; addresses of web services to which the device will connect; web service access credentials; unique device identity via cryptographic tokens; cryptographic certificates to allow the device to validate network connections, operating commands, and the like; reading and recording of make, model, barcode, serial number, or other manufacturer-provided device-specific identification; co-installation of barcode, beacon, or other purchaser-provided identifier; photos of the installed device in situ; geolocation of the installed device in situ.

In one embodiment, a system and method of the present invention are used to configure wireless network settings (SSID, passphrase, etc.) or one or more IOT devices.

In one embodiment, a system and method of the present invention are used to configure wireless network settings (SSID, passphrase, etc.) or one or more IOT devices, and to reset the username/password combinations used to secure those devices from factory defaults to unique values.

In one embodiment, a system and method of the present invention operated to execute a manual execution script, recording serial numbers, device position, and other desirable information for inventory, device provenance, and similar purposes.

In another embodiment, the device or devices are configured with information allowing them to connect to one or more web services, such information may include, but is not limited to, web server addresses, account numbers, secure identification credentials, and license credentials.

In one embodiment, a secured enclave is established initially through proximity based exchange of a local secret (e.g. X.509 certificate), that can later authenticate enclave devices to each other, and to third-parties as belonging to the same owner/user, and authorize commands and actions securely, without ever exposing key security model components to non-local systems/actors—thus limiting external attack.

In one embodiment, a system for generating secure device enclaves comprises a private enclave certificate generator, one or more physical IOT devices; and one or more control devices, wherein the certificate generator is collocated with the physical devices (at exchange time) to be secured, and any co-located control devices (also collected at certificate exchange time) that are to be used at a later time, and the certificate generator is configured to exchange cryptographic certificates, such as X.509 certificates, in a trust-chain rooted in the certificate generator.

In one embodiment, the certificate generator issues certificates over a short-range communications medium, such as Wi-Fi, Bluetooth, Near-Field Communications (NFC) or a physical exchange (e.g. USB drive). The resulting certificates create a trustworthy mechanism for one or more devices, over an untrusted communication channel, such as the Internet, to authenticate and authorize device-to-device or device-to-server-to device communications, including the transmission and receipt of sensor data, and control commands, without exposing key security model elements to the wider internet or exposing the security model to breaches of vendor databases or web services.

The IOT devices and control devices are both brought into proximity with a certificate generator that communicates only over a short-range communications medium. Local pairing (certificate exchange) is then initiated between the device and the enclave certificate generator over the short range communications medium, so that all devices belonging to the enclave receive an X.509 certificate (or any reliable successor certificate standard) from this certificate generator. The DANE protocol (or any reliable successor protocol) is used to sign the X.509 certificates so that any party can verify that all enclave certificates (and only enclave certificates) are in fact derived from the enclave certificate generator. Trust in these certificates, and hence in commands signed by them, is stronger than for certificates provided by a remote source (such as a manufacturer, vendor, installer, or service provider) in that enclave certificates can only be obtained directly from the generator by devices in physical proximity with the generator, which the owner can restrict using physical, rather than cryptographic, security; the enclave certificate generator is difficult to attack remotely to obtain an illicit certificate, since it need never be exposed to the Internet; and the enclave certificate generator protects a smaller number of devices than the typical device manufacturer or service provider, and thus provides a less tempting target for an attacker.

Once any device has exchanged a certificate with the enclave certificate generator, it can authenticate itself as part of the enclave to other enclave devices and the world at large until the enclave revokes its certificate or the time-to-live assigned by the enclave has expired. Enclave control devices and/or sensor monitors, such as cell phones, can now sign their commands and connection requests to other devices in the enclave with short-time-to-live certificates in the enclave trust chain.

Devices secured by membership in the enclave are configured to honor restricted command and communication requests only if signed by an enclave certificate.

Devices secured by membership in the enclave may connect to the internet directly (Wi-Fi) or indirectly (via a hub architecture such as Z-wave or Zigbee). In the latter case, security policies can be enforced by the individual devices, by the hub architecture, or both.

In one embodiment, each device in the enclave enforces an individual security policy determining which commands and communications require enclave signatures.

In another embodiment, the enclave provides certificates of different authority levels to paired devices at the time of pairing. Enclave devices can then discriminate between higher authority commands and lower authority commands, allowing different command and control devices to have different device access levels.

In another embodiment, the enclave enforces common security policies. Either through judicious device selection or through a security policy authority with which devices are registered at the time of pairing.

In another embodiment, the enclave also provides less-trusted certificates over the Internet to remote users, granting them authority over the enclave's devices which may be lower than that of enclave devices, but greater than that of other actors. This will facilitate changing IOT Cloud Service Providers: the old providers' certificates can be revoked, and the new provider granted a new certificate.

In another embodiment, the system also provides a Local Security Policy Engine that can maintain and modify device security policies for the entire enclave. Devices communicate with the security policy engine on receipt of a request to determine if the request should be honored. This allows enclaves to adjust their security policies, potentially in real time, in response to external events. Furthermore, since each enclave can have a different set of security rules, the IOT service providers need not know the enclave's rules—which makes target assessment harder for an external attacker; IOT service providers or device vendor cannot disable local rules even if they are hacked.

In another embodiment, the enclave certificate generator may be configured for integration into a Wi-Fi router or into a hub, such as a Z-wave/ZigBee device hub.

In other embodiments, the enclave certificate generator may be used to secure interoperability among the members of a collection of networked devices that share (or have shared) a common physical location, such as: individual homes, offices, factories, retail stores, warehouses; networked automobiles and user devices; fleet vehicles; utility meters; drone fleets; medical devices; inventories and scanners; and tactical teams and personnel (military, first responders, and the like).

In one embodiment, the system is configured for user/home/organization/private certificates provisioned by a DNS certificate engine to establish trust and enclaves. In another embodiment, the system comprises a dedicated device that issues certs and uses proximity communications (non-internet exchange) to provide the certs to enclave IOT devices and applications. Communications comprise Bluetooth and NFC and other suitable proximity-based communications protocol.

In one embodiment the system comprises a locally-networked certificate generator in association with a domain; a collection of permanent X.509 identity cards for a number of devices; and means of to provide local certificate exchange across a plurality of IOT devices over short-range communications medium.

In one embodiment, a system and method as disclosed herein comprises creating a security enclave, defined by a collection of DANE certificates associated with a local/private DNSSEC Domain (e.g. home, company, family); establishing a home Domain net e.g. myhome.home (or some other domain/name); binding DANE certificate creation to the domain via DNSSEC; and utilizing a specialized DANE certificate creation and distribution capability to securely distribute the certificate to devices and apps via a non-Internet, proximity based communications protocol e.g. Near Field Communications (NFC), Bluetooth, local Wi-Fi (or other suitable means as new local communications proliferate).

In one aspect there is a provided a system comprising a home domain configured for issuing DANE certificates via a non-internet protocol; a router; a certificate hub; one or more devices to be securely connected within a secure enclave and capable of communicating with the router via a non-internet, proximity based communications protocol.

In accordance with another aspect there is provided a non-transitory computer-readable medium having recorded thereon a program that causes a device running an application to execute a method, comprising: establishing a home domain network; binding one or more of a DANE certificate creation to the domain via DNSSEC; distributing the certificate to a device and or application via a non-internet, proximity-based communications protocol, wherein the non-internet proximity based communications protocol comprises NFC or Bluetooth communications, or another suitable means of communication.

The system is configured to permit a device to execute two related processes: one to create, review, and store in a database, approved configurations for each device, and one to retrieve and apply the device-specific approved configuration to the target device (IOT device) when the target device is installed.

In one embodiment, the content of a device's approved configuration is defined by the user/owner, and may maintain different approved configurations for each type of device used and/or the location or purpose of each device.

As used herein, an approved configuration for a device may include automatically-generated unique names, usernames, passwords, and the like, generated from a template or by any other mechanism. Additionally, trust between devices can be enhanced by distributing a shared secret (e.g. an X.509 certificate or other cryptographic or shared secret mechanisms), thereby permitting those devices to securely authenticate and authorize sensitive commands to each other in communication over the Internet or an untrusted network.

In one embodiment, the approved configuration is the same for any and all devices in the enclave, and is used to solely to configure wireless network settings (SSID, passphrase, etc.) or one or more devices.

In one embodiment, multiple approved configurations contain wireless network credentials (SSID/passphrase, x509 certificate, etc.) or one or more devices, and defines how to reset from factory defaults to unique values the username/password combinations used to secure those devices.

In one embodiment, multiple approved configurations are used to configure wireless network settings (SSID, passphrase, etc.) or one or more devices, and to reset the username/password combinations used to secure those devices from factory defaults to unique values, and to execute a manual execution script, recording serial numbers, device position, and other desirable information for inventory, device provenance, and similar purposes.

In one embodiment, multiple approved configurations are used to configure wireless network settings (SSID, passphrase, etc.) or one or more devices, and to reset the username/password combinations used to secure those devices from factory defaults to unique values, and to execute a manual execution script, recording serial numbers, device position, and other desirable information for inventory, device provenance, and similar purposes. Additionally, the device or devices are configured with information allowing them to connect to one or more web services, such information may include, but is not limited to, web server addresses, account numbers, secure identification credentials, and license credentials.

Depending on the embodiment, the web services so configured and credentialed can comprise zero or more purchaser-provided operational services, such as identity and access management, device status, health and safety monitoring, device battery status monitoring, and property management/inventory monitoring; zero or more purchaser-provided or third party analytic services to analyze and use data from the device for any and all purposes authorized by the purchaser; and zero or more purchaser-provided or third party command and control services to operate the device for any and all purposes authorized by the purchaser.

In one embodiment, any of the previous embodiments is enhanced by exchange of secrets from a key generator. These secrets can later authenticate enclave devices to each other, and to third-parties as belonging to the same owner/user, and authorize commands and actions securely, without ever exposing key security model components to non-local systems/actors—thus limiting external attack.

In one embodiment, a system for device configuration comprises a configuration database maintained with pre-defined approved configurations for each type of target device it intends to use and stores it in the organization's approved configuration database. Each time a target device is to be installed, an approved configuration is retrieved from the database and provided to a mobile configuration application in the physical possession of the installation team. The installer of each target device can then use a mobile configuration application (MCA) to correctly and consistently configure each device using local communication mechanisms during the installation process. Once the installation process is complete, the device will have secure and correct networked communications to and from any needed web services.

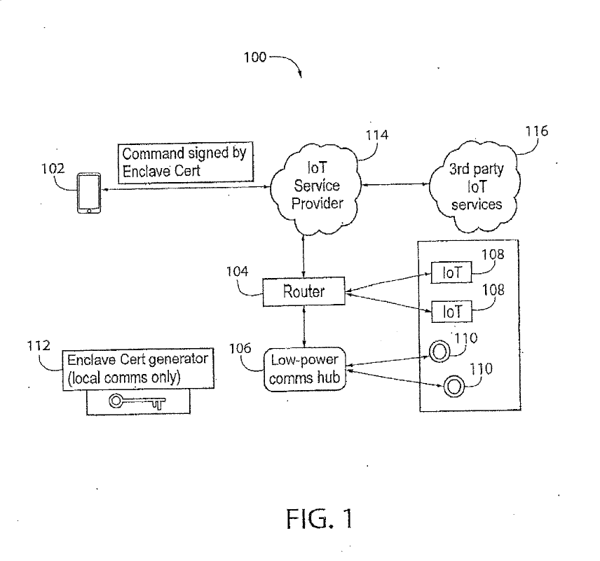

Turning now to the Figures, where shown at FIG. 1 is an overview of a system according to one embodiment of the present invention, comprising a control device 102 (here shown as a smartphone), a router device 104, a communication hub 106, one or more IOT devices (“wifi-enabled”) 108 connected via router 104, one or more IOT devices (non-wifi enabled) 110 connected via low-power communications hub 106, an enclave certificate generator 112, an IOT service provider 114, and one or more third-party IOT services 116.

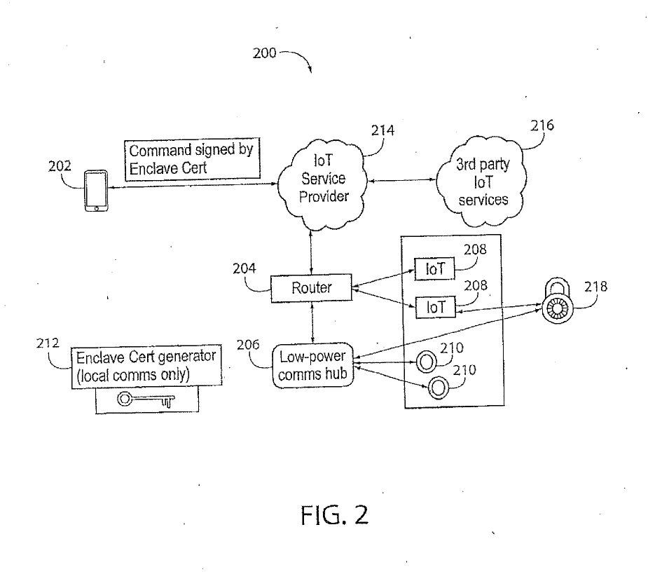

FIG. 2 shows an overview of a system according to another embodiment of the present invention, comprising a control device 202 (here shown as a smartphone), a router device 204, a low-power communication hub (non-wifi) 206, one or more IOT devices (“wifi-enabled”) 208 connected via router 204, one or more IOT devices (non-wifi enabled) 210 connected via low-power communications hub 206, an enclave certificate generator 212, an IOT service provider 214, one or more third-party IOT services 216, and a local security policy module 218. The local security module allows different devices to apply different policies to the authentication of incoming commands, such as what to do if a command is signed by an expired cert.

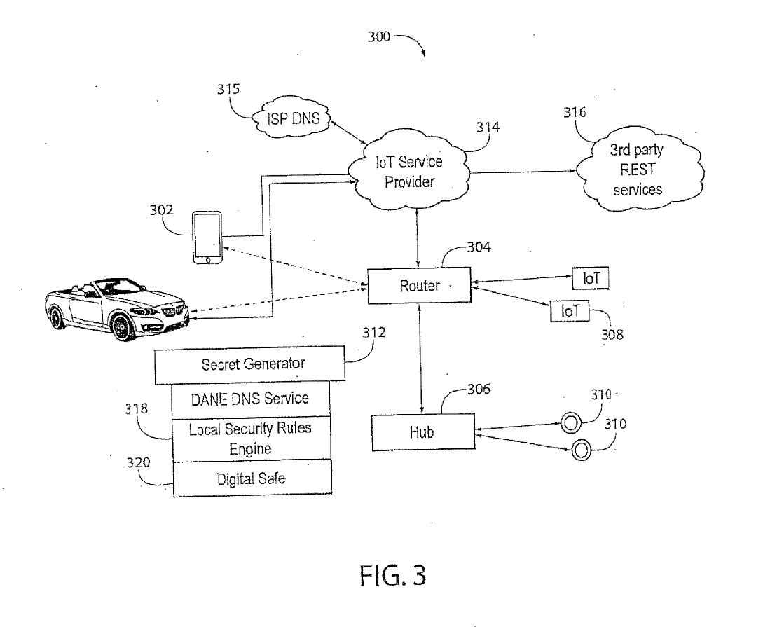

FIG. 3 shows an overview of a system according to another embodiment of the present invention, comprising a control device 302 (here shown as a smartphone and/or an automobile), a router device 304, a low-power communication hub (non-wifi) 306, one or more IOT devices (“wifi-enabled”) 308 connected via router 304, one or more IOT devices (non-wifi enabled) 310 connected via low-power communications hub 306, an IOT service provider 314, one or more third-party IOT services 316, an ISP DNS 315, and a key generator device 320 comprising an certificate generator 312 and a local security policy module 318. This embodiment emphasizes that once trust is established via physical proximity, it can be maintained over large distances.

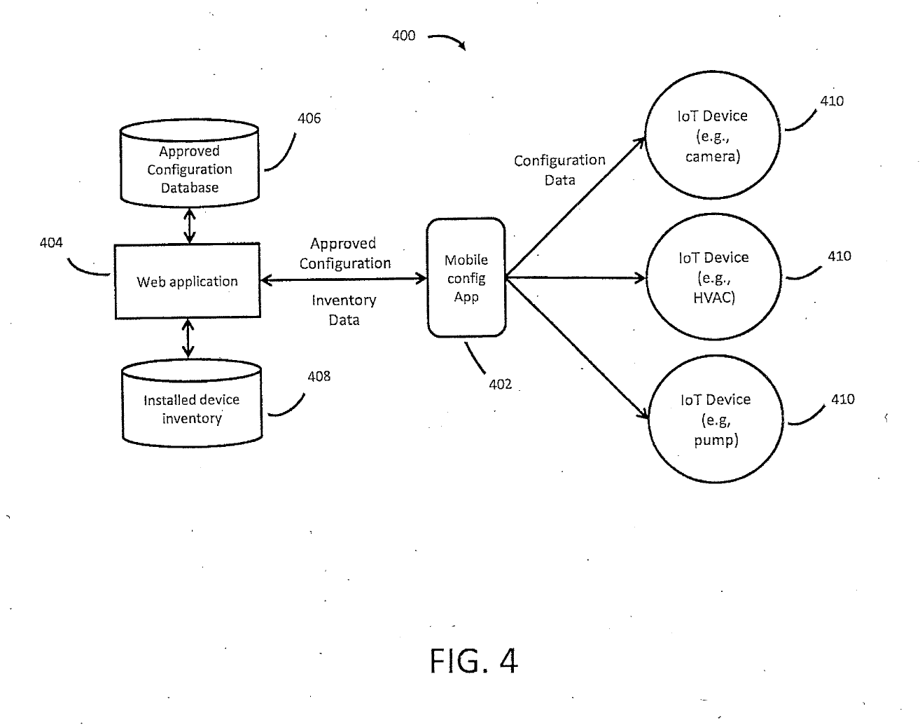

FIG. 4 shows an overview of a system 400 according to exemplary embodiment of the present invention comprising a mobile device (control device) 402 in communication via a web-based application 404 configured for accessing an approved configuration database 406, whereon is stored user-defined and approved configurations specific to individual IOT devices and specific to each device's intended use by user/operator of the IOT devices to be so configured, to include networks to be used by the device, credentials to be used in accessing those networks, addresses and access/authentication/license credentials for any web services the user/operator wishes to connect the device to, whether operated by the user/operator or a third party, and any additional software the purchaser wishes to be install on the IOT device as part of an onboarding process, and an installed device inventory database 408, whereon is stored every device to which one or more approved configurations have been applied by the mobile device 402, along with device information collected during installation, as defined by the user/operator in the device's approved configuration, such as serial numbers, barcodes, pictures of the installed device, IP addresses, MAX addresses, unique username/password combinations used to authenticate to the device, etc. Mobile device 402 in turn relays configuration data retrieved from the approved configuration database 406 to one or more target devices, wherein target devices comprise one or connected IOT devices, for example, a camera, a home electronic device, a pump, or other sensors or effectors, and the like which are configured for communication over the internet. This embodiment emphasizes that physical proximity can be used to increase security even without using the local certificate generator: proximity to the mobile config app 402 ensures that newly onboarded devices are nonetheless onboarded consistent with the user/purchaser's policies.

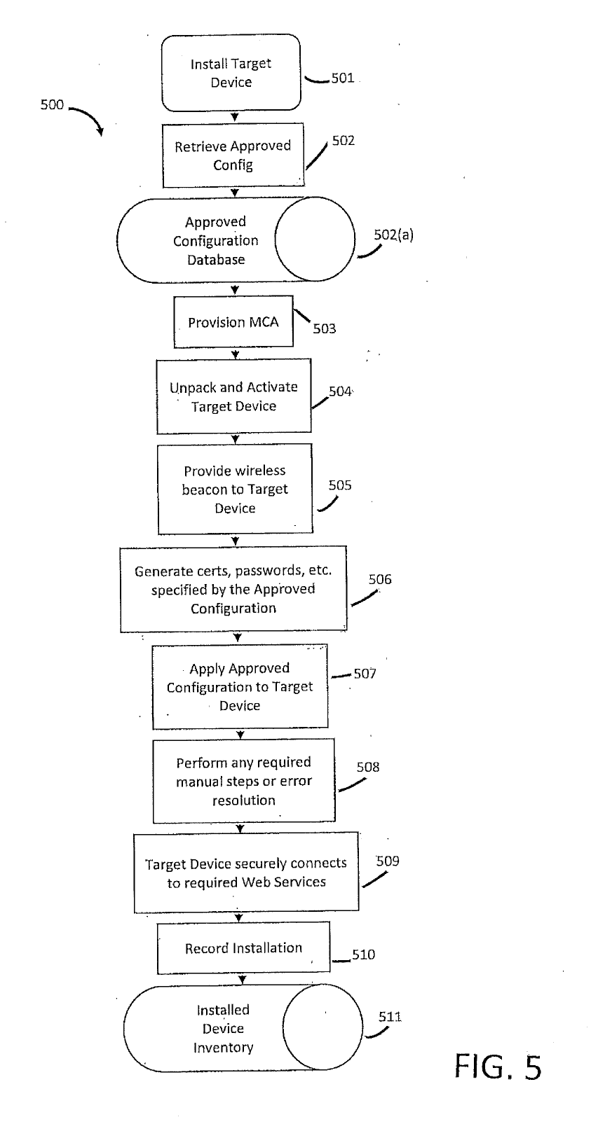

FIG. 5 shows an overview of a process 500 for applying an approved configuration to an un-configured device (target device), according to one embodiment of the present invention. Process 500 begins when an un-configured (target) device is installed at step 501, an approved configuration is retrieved from an approved configuration database at step 502, at step 503 a configuration module configured as a mobile configuration application (MCA) is provisioned on a mobile device, that is, the device connects to a web application (shown previously in FIG. 4), authenticates itself as bellowing to an appropriate installer (this authentication may be done in a number of ways, including physical proximity, username/password challenges, cryptographic certificates, biometrics, etc.) and is given one or more approved configurations. At step 504 the MCA displays diagrams, images, and/or written instructions describing any manual steps needed in order to activate the target device properly, as specified in the approved configuration. At step 505 the MCA initiates a mobile hotspot or other temporary, short range wireless network with which the target device will connect either automatically or manually. The wireless protocol may vary from device to device: if the device supports more than one such protocol, the approved configuration may specify which to use. At step 506 the MCA generates any certificates, passwords, user names, etc. that may be specified by the approved configuration. (This is useful for ensuring that each device receives unique accounts credentials, which makes for a more difficult overall attack surface for the organization's networks.) At step 507 the MCA automatically installs permanent network credentials, changes default accounts and/or passwords, and configures web services on the target device over the temporary wireless connection established in step 505, using APIs already present on the target device, if present, or remote configuration technologies (such as Ansible or Puppet). The MCA also automatically retrieves device metadata, such as serial numbers, MAC addresses, IP addresses, etc. that the device can supply, as specified by the approved configuration. At step 508 the MCA displays diagrams, images, and/or written instructions describing any device configuration that could not be accomplished automatically in step 507, to include all forms of error resolution, e.g., failure to connect, failure to access by expected passwords, etc. Manual steps that are not error-resolution include describing the device and its location by any number of means, to include photographs, GPS, written descriptions, or any device-specific configuration steps that cannot be performed in step 507. At step 509, upon successful completion of steps 504-508, the target device is now configured in accordance with the policies of the operator/user as specified in the approved configuration. At step 510 the MCA returns a record of all activities carried out and all information collected during steps 504-508 to the web service for inclusion in the inventory database. At step 511 the inventory dataset permanently stores the complete record of the installation of the device.

In one embodiment, an un-configured target device is configured according to the following example involving a user/operator comprising a purchasing organization that decides to purchase and/or deploy one or more connected IOT devices into a new or existing deployment and initiates the process of the present invention. The purchasing organization conducts a procurement process, which may vary from organization to organization, to acquire one or more target devices of one or more types. The devices and associated software may be acquired from other vendors or developed in house. If suitable devices are already in the possession of the purchasing organization, no procurement may be necessary, but a decision must still be taken by the purchasing organization to deploy the devices for some purpose. In all cases the exit criteria is a decision to install one or more devices, of one or more types, of specific models and versions, for an agreed purpose, and connect them to one or more of the organization's networks and to one or more web services. The purchasing organization then conducts a review process among all stakeholders, which may vary from organization to organization, to determine how this device can be integrated into the organizations network in such a way as to render it fit for purpose and to reduce the security risks (associated with the introduction of any networked device, such as unwanted access to the device or the use of the device as a platform from which to launch attacks on the rest of the organization) to a degree that satisfies the organization. Ideally, this review will involve security professionals and the users of the device as stakeholders, and include a review of the device's use, the criticality of that use, a review of known potential vulnerabilities of the device(s), an assessment of the risks posed by the device to other operations of the organization, and plans to mitigate those risks. In all cases the exit criteria include the creation of, and an acceptance of the risks posed by, an approved configuration as described above.

The review process described here produces an approved configuration for each device to be deployed by this invention. This configuration will include as many of the following elements as the purchasing organization determined to be desirable and feasible, including but not limited to:
i. the wireless network(s) over which the device will connect, along with any credentials (passphase, x509 certificate, etc.) needed to gain access to said network, and any other metadata needed to properly use it, such as gateways, firewalls, protocol versions, etc. Network addresses and access credentials for any web services with which the device is intended to initiate connections. Network addresses and access credentials for any web services which are preinstalled on the device by its manufacturer, and which are not configured by the purchasing organization, are not included. Such web services are included, but not limited to, messaging services, ingest points for data analytics, ingest points for decision-making services, control interfaces of other IOT devices, device monitoring systems, etc. Such web service include other services operated by the purchasing organization, or 3^{rd} party services.
ii. Authentication credentials for any web services which are expected to initiate contact with the device, for any purpose, excepting authentication credentials for any web services which are preinstalled on the device by its manufacturer, and which are not configured by the purchasing organization, which are not included. Such web services are included, but not limited to, messaging services, ingest points for data analytics, ingest points for decision-making services, control interfaces of other IOT devices, device monitoring systems, etc.
iii. In addition to the configuration of software already present on the device, the purchasing organization may, depending on the device, wish to and be able to install (and configure as above) additional software of any nature that was not originally installed on the device by its manufacturer.
iv. A description of the make, model, and version of the device(s) to which this configuration applies. These may be ranges of make, model, and version, depending on technical feasibility and the intent of the purchasing organization.
v. A description to be interpreted by the Mobile Configuration Application (MCA) of the means to be used to access the specific device and apply the configuration, to include both manual steps and wireless access protocols and credentials supported by the device.
vi. A description of any other information to be collected during installation as desired by the purchasing organization, including the device's location (written, photographic, GPS, etc.), serial number or other identifying details, during steps described herein.

In a separate example, IOT devices, unlike cloud services, can be brought into close physical proximity for truly secure key exchanges using local communications for pairing e.g. NFC, Bluetooth, Wi-Fi, or even physical exchange. In one embodiment a secret generator issues certs using proximity communications can build trust chains among enclave devices that do not rely on external providers and that enjoy local proximately based secure key exchange. In one embodiment, such a system comprises four components: a device in the physical enclave (home, office, etc.) that is the secret generator—a key generator—of the enclave. The key generator generates all highly-trusted X509 certificates at the root of the enclave's trust chains. Devices are added to the enclave by pairing with the box over Wi-Fi, Bluetooth, NFC, or physical exchange via USB. The pairing mechanism ensure all devices are in proximity to the key generator when paired. A local-only web service allows administration: key revocation, etc., while an internet domain unique to the enclave is created and associated with the key generator device via standard DANE/DNSSEC protocols. This allows anyone outside the enclave to verify that certs claiming to be from this enclave in fact are a collection of IOT Apps and Devices that honor the API and constraints.

It will be clear to a person skilled in the art that features described in relation to any of the embodiments described above can be applicable interchangeably between the different embodiments. The embodiments described above are examples to illustrate various features of the invention, and they are not exhaustive or exclusive. Throughout the description and claims of this specification, the words “comprise” and “contain” and variations of them mean “including but not limited to”, and they are not intended to (and do not) exclude other additives, components, materials or steps. Throughout, the singular encompasses the plural unless the context otherwise requires. In particular, where the indefinite article is used, the specification is to be understood as contemplating plurality as well as singularity, unless the context requires otherwise.

Features, materials, characteristics, described in conjunction with a particular aspect, embodiment or example of the invention are to be understood to be applicable to any other aspect, embodiment or example described herein unless incompatible therewith. The invention is not restricted to the details of any foregoing embodiments. The invention extends to any novel one, or any novel combination, of the features disclosed in this specification (including any accompanying claims, abstract and drawings), or to any novel one, or any novel combination, of the elements so disclosed.

1. A non-transitory computer-readable medium having recorded thereon a program that causes a control device running an application to execute a method, comprising: distributing, via a key generator module of the control device, a certificate to an IOT device or application via a non-internet, proximity-based communications protocol, wherein the non-internet proximity based communications protocol comprises NFC or Bluetooth communications, or another suitable means of communication.

2. A system for device configuration, comprising a configuration database maintained with pre-defined approval configurations for a plurality of target devices to be installed within a local network of devices; and a control device, wherein the control device is configured with a configuration module configured to permit the control device to execute two related processes: one to create, review, and store in the configuration database, approved configurations for a device, and one to retrieve and apply the device-specific approved configuration to a target device, wherein the target device is an IOT device, and wherein the target device configuration is installed in physical proximity to the control device using local communications channels.

3. The system of claim 2, wherein an approved configuration is defined by the user/owner, and may maintain different approved configurations for each type of device used and/or the location or purpose of each device.

4. The system of claim 2, wherein an approved configuration for a device may include automatically-generated unique names, usernames, passwords, and the like, generated from a template or by any other mechanism.

5. The system of claim 2, further comprising a devices configured with a key generator module configured for distributing a shared secret, wherein the shared secret is an X.509 certificate or other cryptographic or shared secret mechanisms, thereby permitting devices to securely authenticate and authorize sensitive commands to each other in communication over the Internet or an untrusted network.

6. The system of claim 2, further comprising multiple approved configurations to configure wireless network settings (SSID, passphrase, etc.) or one or more devices, and to reset the username/password combinations used to secure those devices from factory defaults to unique values, and to execute a manual execution script, recording serial numbers, device position, and other desirable information for inventory, device provenance, and similar purposes.

7. The system of claim 2, wherein IOT devices comprise one or more connected devices comprising a portable electronic device, a smartphone, a camera, a home electronic device, and the like.

8. The system of claim 2, wherein the locality of the local communications channel used to configure devices in physical proximity to the control device is ensured by using low-power, short range communications protocols such as Bluetooth, ZigBee, or any similar successor protocols.

9. A method for applying an approved configuration to an un-configured device, comprising:
retrieving, via a control device configured with a configuration module and a mobile configuration application, from a configuration database an approved configuration;
connecting, via the control device to a web application;
authenticating the control device as belonging to an appropriate installer, either by physical proximity, username and password, or cryptographic certificates;
displaying any instructions for manual input required in order to activate the target device;
initiating a mobile hot spot or other short-range wireless network with which the target device will connect, via the mobile configuration application on the control device;
generating, via the mobile configuration application, any certificates, passwords or other authentication information;
installing network credentials; and
returning a record of activities carried out and information collected for inclusion in an inventory database.
